(19) United States
(12) Patent Application Publication
(10) Pub. No.: US 2025/0162378 A1
(43) Pub. Date: May 22, 2025

(54) TEMPERATURE-CONTROL SYSTEM, METHOD FOR CONTROLLING THE TEMPERATURE OF A TEMPERATURE-CONTROL SYSTEM, AND MOTOR VEHICLE

(71) Applicant: KAUTEX TEXTRON Gmbh & Co. KG, Bonn (DE)

(72) Inventors: Moritz Lipperheide, Bonn (DE); Gero Mimberg, Koln (DE)

(21) Appl. No.: 18/839,161

(22) PCT Filed: Feb. 14, 2023
(86) PCT No.: PCT/EP2023/053560

§ 371 Date: Aug. 16, 2024

(30) Foreign Application Priority Data
Feb. 22, 2022 (DE) 10 2022 104 200.6

(51) Int. Cl. B60H 1/00

(52) U.S. Cl. CPC B60H 1/00278; B60H 1/00828; B60H 1/00885; B60H 2001/00307

(57) ABSTRACT

A temperature-control system for controlling the temperature of a traction battery of a motor vehicle using a heat transfer medium in a temperature-control circuit. The temperature-control system includes a battery housing which has an evaporation device for evaporating the heat transfer medium and which forms a closed interior with at least one receiving position for a battery cell. A lower region of the battery housing is designed to receive the heat transfer medium. A collecting container receives the heat transfer medium. A heat transfer device has a condenser for cooling the heat transfer medium. A pump conveys the heat transfer medium. An electronic control and/or regulating unit receives a temperature of the heat transfer medium and/or the temperature of the battery cell, and/or the current strength of the battery cell and/or the wet steam content at the fluid drain of the battery housing. According to at least one manipulated variable of the temperature control system, the system controls and/or regulates the temperature of the at least one battery cell and/or the wet steam content at the fluid drain of the battery housing.

The invention relates to a temperature control system, a method for temperature control of a temperature control system and a motor vehicle.

Various types of high-performance batteries are known from the prior art. In high-performance batteries such as those used, for example, as traction batteries in motor vehicles with electric drives, high levels of power are converted during charging and discharging. Such high-performance batteries can currently be operated with voltages of up to several hundred volts or even up to 1000 volts. In addition, the charging and discharging of currents of several hundred amperes up to 1000 amperes can currently occur. In principle, higher voltages and/or currents are also possible in future developments.

In the high-performance batteries, the strong charging and discharging currents cause thermal losses which lead to the high-performance batteries heating up. In order to protect the batteries from thermal damage and to achieve high efficiency, it is important to keep the high-performance batteries within a desired temperature range. In order to avoid exceeding the temperature range, heat must be removed from the batteries. This is all the more important, the stronger the currents and the associated greater thermal losses, so that the batteries remain in the desired temperature range even with such large currents. Current battery cells using lithium-ion technology work best in a narrow temperature range with great temperature homogeneity and low temperature fluctuation within and between the battery cells. A reliable operation of the high-performance batteries and a long service life with consistent performance can be achieved under such conditions.

In order to ensure these conditions and to avoid exceeding the temperature range, the battery cells of the current high-performance batteries are cooled at least in phases during operation, i.e. during charging and/or discharging. Different types of cooling are currently used. For example, liquid cooling involves a heat exchanger through which a liquid heat transport medium flows. The heat exchanger is usually arranged below the battery cells, with the heat exchanger being thermally conductively connected to the battery cells via a contact heat transfer. The heat capacity of the liquid heat transport medium is used to absorb the heat emitted by the battery cells or the battery as a whole via a temperature difference and to release it into the environment either directly or via an air-conditioning circuit. Electrically conductive water or a likewise electrically conductive water-glycol mixture is used as the heat transport medium, for example, which is why a reliable separation of the heat transport medium from the battery cells is required.

A similar cooling can also be realized with air as the heat transport medium. Since air, unlike water, is not electrically conductive, the battery cells can be in direct contact with the heat transport medium and, for example, be overflown by it. A heat exchanger is therefore not absolutely necessary.

In the systems currently available, the heat transport medium circulates actively in order to dissipate the heat dissipated by convection. In an active circulation, the heat transport medium is actively circulated in order to dissipate the heat from the battery cells.

As a further development of a liquid cooling process with a heat exchanger that is in contact with the battery cells, the liquid heat transport medium can be evaporated by the heat absorption from the heat exchanger, which leads to a higher heat transfer and, due to the evaporation enthalpy, to a high heat absorption per mass of the heat transport medium. After a condensation, the heat transport medium can be returned to the heat exchanger in the liquid state.

There are also some cooling systems in development with a liquid heat transport medium, for example in industrial applications for high-voltage traction batteries, that do not have a heat exchanger that is in contact with the battery cells. Comparable to the use of air as a heat transport medium, cooling is effected by a direct flow of the liquid heat transport medium around the components to be cooled. An important property of the liquid heat transport medium is therefore its dielectricity, since the heat transport medium is in direct contact with the battery cells, i.e., with electrically conductive and potential-carrying components. In addition, the evaporation enthalpy of the dielectric, liquid heat transport medium and the associated high heat transfer can also be used if the heat transport medium evaporates during the heat transfer due to the heat input from the battery cells to be cooled. Such cooling is referred to as two-phase immersion cooling.

The object of the invention is that of providing an improvement over or an alternative to the prior art.

According to a first aspect of the invention, the object is achieved by a temperature control system for controlling the temperature of a traction battery of a motor vehicle with a heat transfer medium in a temperature control circuit, comprising:
a battery housing which has an evaporation device for evaporating the heat transfer medium and which forms a closed interior with at least one receiving position for at least one battery cell, a lower region of the battery housing being designed to receive the heat transfer medium;
a collecting container for receiving the heat transfer medium, in particular a collecting container operatively connected to a heating device for heating the heat transfer medium, in particular with a heating device which is designed to be able to vary a first temperature of the heat transfer medium in the collecting container depending on a heating device manipulated variable;
a heat transfer device having a condenser for cooling the heat transfer medium, in particular a heat transfer device which is designed to be able to vary a second temperature of the heat transfer medium at a fluid drain of the condenser depending on a heat transfer device manipulated variable;
a pump for conveying the heat transfer medium, in particular a pump which is designed to be able to vary a heat transfer medium volume flow depending on a pump manipulated variable; and
an electronic control and/or regulating unit, wherein the electronic control and/or regulating unit is designed to receive a temperature, in particular the temperature of the designated heat transfer medium and/or the temperature of the at least one designated battery cell, and/or the current strength of the at least one designated battery cell and/or the wet steam content at the fluid drain of the battery housing and, in accordance with at least one manipulated variable of the temperature control system, in order to control and/or regulate the temperature of the at least one battery cell and/or the wet steam content at the fluid drain of the battery housing.

In this regard, the following is explained conceptually:

It is first expressly noted that in the context of the present patent application, indefinite articles and numbers such as “one,” “two,” etc. should generally be understood as being “at least” statements, i.e. as “at least one . . . ,” “at least two . . . ,” etc., unless it is clear from the relevant context or it is obvious or technically compelling to a person skilled in the art that only “exactly one . . . ,” “exactly two . . . ,” etc. can be meant.

In the context of the present patent application, the expression “in particular” should always be understood as introducing an optional, preferred feature. The expression should not be understood to mean “specifically” or “namely.”

A “temperature control system” is understood to mean a device through which fluid can flow and which is designed to control the temperature of, in particular to cool and/or heat, a traction battery of a motor vehicle with a heat transfer medium in at least one “temperature control circuit.” The temperature control system can have a heat transfer medium.

The temperature control system essentially consists of a battery housing, a heat transfer device and a pump. The temperature control system can have a collecting container. The temperature control system can have an electronic control and/or regulating unit.

Preferably, the temperature control power required by a traction battery can be provided by means of a temperature control system and transported into and/or out of a battery housing by a designated heat transfer medium by its temperature in a temperature control circuit being changed.

In a temperature control circuit, the pump can be fluidically connected directly or indirectly to the battery housing. The pump can be arranged directly or indirectly in the flow direction of the heat transfer medium upstream or downstream of the fluid inlet of the battery housing. The battery housing can be fluidically connected directly or indirectly to the heat exchanger. The heat exchanger can be fluidically connected directly or indirectly to the collecting container. The collecting container can be fluidically connected directly or indirectly to the pump.

Individual components of the temperature control circuit can optionally be connected to each other by lines. This allows the components of the temperature control circuit to be arranged at different positions within a motor vehicle.

Functionally interconnected components of the temperature control circuit can also be arranged directly adjacent to one another so that individual, multiple or all lines can be dispensed with. The pump can be arranged adjacent to the battery housing and/or the collecting container or can be part of a line between the battery housing and the collecting container or part of the collecting container or part of the battery housing. The heat exchanger can be located adjacent to the battery housing or can be part of the battery housing. The collecting container can be located adjacent to the heat exchanger or can be part of the heat exchanger. The collecting container can be located adjacent to the battery housing or can be part of the battery housing.

In particular, individual components of the temperature control circuit can be directly connected to one another in such a way that the temperature control circuit has, at least in part, a common, coherent structure, or the temperature control circuit be designed at least in part as an integral component. This means that the temperature control circuit can be arranged at least as regards components in one piece in a motor vehicle. In addition, a temperature control circuit designed at least in part as an integral component can be particularly easily installed in a motor vehicle, removed from a motor vehicle and replaced in a motor vehicle.

A “heat transfer medium” is understood to mean, in particular, a fluid which can be used to transport heat and/or cold by means of a volume flow of the heat transfer medium, wherein the heat transfer medium can have different temperature states. In particular, the heat transfer medium can be a gaseous and/or liquid substance or a gaseous and/or liquid substance mixture.

The heat transfer medium can expediently be designed as a “dielectric” heat transfer medium. A dielectric heat transfer medium is not electrically conductive, so it can act as an insulator between individual bodies around which a dielectric heat transfer medium flows. In particular, an electrical insulation can be formed between individual battery cells if the dielectric heat transfer medium connects them to each other.

A “battery housing” is understood to mean, in particular, a structure which forms an enclosed interior space with at least one receiving position for a battery cell and which can have at least one battery cell.

The battery housing may have a “lower region.” The lower region of the battery housing can also extend over the lower 10% of a height extension of the battery housing, wherein the height extension is understood to mean the absolute height extension from the lowest point of the battery housing to the highest point of the battery housing, preferably over the lower 20% of the height extension, again preferably over the lower 30% of the height extension, again preferably over the lower 40% of the height extension and particularly preferably over the lower 50% of the height extension.

The fluid inlet of the battery housing can be arranged in the lower region of the battery housing.

The fluid drain of the battery housing can be arranged in the upper region of the battery housing.

The lower region of the battery housing can be designed to accommodate the designated liquid heat transfer medium located in the battery housing.

In the particularly preferred embodiment of a temperature control system designed for two-phase immersion cooling, the lower region of the battery housing can be designed to accommodate a liquid phase of the heat transfer medium. Preferably, a mixed phase and/or a gaseous phase of the heat transfer medium can be accommodated in a region above the lower region of the battery housing. In other words, an evaporation device can be arranged above the lower region of the battery housing.

The battery housing may have an “upper region.” The upper region of the battery housing can also extend over the upper 10% of the height extension of the battery housing, preferably over the upper 20% of the height extension, again preferably over the upper 30% of the height extension, again preferably over the upper 40% of the height extension and particularly preferably over the upper 50% of the height extension.

The upper region of the battery housing can be designed to accommodate the designated gaseous heat transfer medium located in the battery housing.

It should be expressly mentioned that, in a preferred operating mode of the temperature control system, a designated heat transfer medium can enter the battery housing through the fluid drain of the battery housing and can exit the battery housing through the fluid inlet of the battery housing. In otherwords, during selected operation, in particular when the at least one battery cell is heated up, the battery housing can also be flowed through in a direction opposite to the flow direction designated for cooling the traction battery.

An “evaporation device” is a device in which a material flow can be evaporated while absorbing heat. Advantageously, the material flow is designed as a volume flow of a designated heat transfer medium.

Further advantageously, an evaporation device is used to transfer the heat from the at least one designated battery cell of a designated traction battery to a designated liquid heat transfer medium, so that the designated liquid heat transfer medium can evaporate while absorbing this heat.

In other words, in an evaporation device, heat is absorbed from the at least one designated battery cell in a designated heat transfer medium.

A “collecting container” can be understood to mean any container that is suitable for collecting a fluid in an enclosed interior space. In particular, a collecting container can hold a liquid and/or gaseous fluid or fluid mixture. A collecting container can expediently hold a dielectric fluid and further expediently a dielectric heat transfer medium.

The collecting container may have a “lower region.” The lower region of the collecting container can also extend over the lower 10% of the height extension of the collecting container, where the height extension is understood to mean the absolute height extension from the lowest point of the collecting container to the highest point of the collecting container, preferably over the lower 20% of the height extension, again preferably over the lower 30% of the height extension, again preferably over the lower 40% of the height extension, and particularly preferably over the lower 50% of the height extension. Furthermore, the lower region of the collecting container can extend over the lower 60% of the height extension, preferably over the lower 70% and particularly preferably over the lower 80% of the height extension of the collecting container.

The fluid drain of the collecting container can be arranged in the lower region of the collecting container.

The fluid inlet of the collecting container can be arranged in the lower region of the collecting container.

The lower region of the collecting container can be designed to receive the designated liquid heat transfer medium in the collecting container.

In the particularly preferred embodiment of a temperature control system designed for two-phase immersion cooling, the lower region of the collecting container can be designed to accommodate a liquid phase of the heat transfer medium. Preferably, a mixed phase and/or a gaseous phase of the heat transfer medium can be accommodated in a region above the lower region of the collecting container.

The collecting container may have an “upper region.” The upper region of the collecting container can also extend over the upper 5% of the height extension of the collecting container, preferably over the upper 10% of the height extension, again preferably over the upper 15% of the height extension and again preferably over the upper 20% of the height extension.

The fluid inlet of the collecting container can be arranged in the upper region of the collecting container.

The fluid drain of the collecting container can be arranged in the upper region of the collecting container.

The upper region of the collecting container can be designed to receive the designated gaseous heat transfer medium in the collecting container.

The collecting container can be arranged below a condenser so that the collecting container has a lower geodetic height than the condenser when used as intended in the motor vehicle. This allows liquid to drain from the condenser into the collecting container. In other words, it can be ensured that liquid does not remain in the collecting container.

It should be expressly mentioned that, in a preferred operating mode of the temperature control system, a designated heat transfer medium can enter the collecting container through the fluid drain of the collecting container and/or can exit the collecting container through the fluid inlet of the collecting container.

A “heating device” is a device that can transfer heat to a fluid that is in operative connection with the heating device. In other words, the temperature of a fluid in operative connection with the heating device can be increased by heat being released from the heating device to the fluid.

The heating device can be designed such that the heating device is in direct operative connection with a fluid. In particular, the heating device can be designed such that the heating device, in particular the surface of the heating device, and a fluid located in the collecting container can be in direct contact with one another.

Alternatively or additionally, the heating device can be designed such that the heating device is indirectly in operative connection with a fluid.

In particular, the collecting container can have a heating device which is designed to achieve an advantageous temperature in the collecting container.

As a result, the designated heat transfer medium fed into the battery housing by a pump can enter the battery housing at an increased temperature so that heat can be released to the at least one designated battery cell due to the increased temperature of the designated heat transfer medium. This makes it possible for a designated battery cell to provide or absorb a high power density more quickly, even at low ambient temperatures. This can improve cold-start capability.

A “heat transfer device” is a device designed to be capable of transferring thermal energy from one material flow to another material flow. Preferably, the material flows of a heat transfer device are spatially separated by a heat-permeable wall.

A “condenser” is a device in which a material flow can be liquefied while releasing heat. Advantageously, the material flow takes the form of a volume flow of a designated heat transfer medium.

The condenser may have a “lower region.” The lower region of the condenser can also extend over the lower 10% of the height extension of the condenser, wherein the height extension is understood to mean the absolute height extension from the lowest point of the condenser to the highest point of the condenser, preferably over the lower 20% of the height extension, again preferably over the lower 30% of the height extension, again preferably over the lower 40% of the height extension and particularly preferably over the lower 50% of the height extension. Furthermore, the upper region of the collecting container may extend only over the lower 30% of the height extension, preferably over the lower 20% and particularly preferably over the lower 10% of the height extension of the condenser.

The fluid drain of the condenser can be arranged in the lower region of the condenser.

The fluid inlet of the condenser can be arranged in the lower region of the condenser.

The condenser can have an “upper region”. The upper region of the condenser can also extend over the upper 5% of the height extension of the condenser, preferably over the upper 10% of the height extension, again preferably over the upper 15% of the height extension, and again preferably over the upper 20% of the height extension.

The fluid inlet of the condenser can be arranged in the upper region of the condenser.

The fluid drain of the condenser can be located in the upper region of the condenser.

Another advantage is that a condenser is used to transfer the heat in a designated gaseous heat transfer medium to a fluid circuit that is in operative connection with the condenser. The fluid circuit that is in operative connection with the condenser can take the form of the environment and/or another air-conditioning circuit.

In other words, in a condenser, heat is released from a designated heat transfer medium so that the designated heat transfer medium can liquefy.

A “pump” can be understood as any type of pump that is designed to convey a fluid.

An “electronic control and/or regulating unit” can be understood as a device which is designed to monitor and/or control and/or regulate the temperature control system.

The electronic control and/or regulating unit may have an interface for receiving data, an interface for transmitting data and a device for processing data. In particular, the device for processing data can be designed to execute an algorithm, in particular implementing a method according to a second aspect of the invention. Preferably, the electronic control and/or regulating unit can have a device for storing data, in particular a data memory.

The electronic control and/or regulating unit can be operatively connected to the battery housing so that a signal representing a current strength of the at least one designated battery cell and/or a temperature of the at least one designated battery cell and/or a temperature of the designated heat transfer medium and/or a pressure of the designated heat transfer medium and/or a wet steam content at the fluid drain of the battery housing can be received, in particular via the interface for receiving data. In particular, a signal representing a temperature of the at least one designated battery cell and/or a temperature of the designated heat transfer medium and/or a pressure of the designated heat transfer medium and/or a signal representing the wet steam content at the fluid drain of the battery housing can be received from the battery management system of the traction battery.

The electronic control and/or regulating unit can be configured to control and/or regulate a temperature of the at least one designated battery cell and/or a temperature of the designated heat transfer medium and/or a pressure of the designated heat transfer medium and/or the wet steam content at the fluid drain of the battery housing by specifying at least one manipulated variable of the temperature control system. The specification of a manipulated variable and/or the transmission of a manipulated variable can be understood as the specification of a value for the manipulated variable. Receiving a temperature and/or a wet steam content can be understood as reading in at least one value for the temperature and/or the wet steam content.

The electronic control and/or regulating unit can be operatively connected to a heating device of the collecting container so that a manipulated variable can be transmitted from the electronic control and/or regulating unit to the heating device. The manipulated variable can be a heating device manipulated variable by means of which the heating device can vary a “first temperature” of the heat transfer medium in the collecting container.

The electronic control and/or regulating unit can be operatively connected to a pump so that a manipulated variable can be transmitted from the electronic control and/or regulating unit to a pump. The manipulated variable can be a pump manipulated variable by which the pump can vary a heat transfer medium volume flow.

The electronic control and/or regulating unit can be operatively connected to a heat transfer device so that a manipulated variable can be transmitted from the electronic control and/or regulating unit to the heat transfer device. The manipulated variable can be a heat transfer device manipulated variable by which the heat transfer device can vary a “second temperature” of the heat transfer medium at the fluid drain of the condenser.

Here, a temperature control system, in particular a temperature control system for controlling the temperature of a traction battery of a motor vehicle, is proposed which has an electronic control and regulation unit.

Preferably, the temperature control system proposed here can be used to control the temperature of a traction battery by means of a two-phase immersion cooling.

In particular, a temperature control system can be implemented in which an electronic control and regulating unit is set up to receive a state variable, in particular a temperature of the at least one designated battery cell and/or a temperature of the designated heat transfer medium, in particular at the fluid inlet of the battery housing, and/or a pressure of the designated heat transfer medium, in particular at the fluid inlet of the battery housing, and/or a current strength of the at least one designated battery cell and/or a wet steam content of the designated heat transfer medium at the fluid drain of the battery housing, in particular via the interface for receiving data, and to transmit at least one manipulated variable of the temperature control system for controlling and/or regulating the temperature control system, in particular via the interface for transmitting data, in particular for controlling and/or regulating the temperature of the at least one designated battery cell and/or of the wet steam content of a designated heat transfer medium at the fluid drain of the battery housing.

In two-phase immersion cooling, the evaporation enthalpy of a designated heat transfer medium can be used to increase the temperature control performance. In this way, a particularly efficient temperature control system can be achieved, which is at the same time suitable for use with a high power density of the at least one designated battery cell.

A designated heat transfer medium can be pumped into the battery housing in the liquid state of aggregation by the pump and can be at least partially evaporated there in the evaporation device of the battery housing by absorbing the heat from the at least one designated battery cell. In this way, in addition to the temperature change of the heat transfer medium, the evaporation enthalpy of the designated heat transfer medium can also be used to provide the required temperature control performance so that an amount of heat can be removed from the at least one designated battery cell. After leaving the battery housing, the designated heat transfer medium can while releasing heat be liquefied again in a heat transfer device having a condenser. In particular, the temperature of the heat transfer medium can be further lowered after liquefaction. The liquid heat transfer medium can be pumped back into the collecting container by the pump. From there, the heat transfer medium can be pumped back into the battery housing in order to again remove heat from at least one designated battery cell by evaporation.

The electronic control and regulating unit can transmit a manipulated variable that is suitable for providing the required temperature control performance, in particular a required heating performance and/or a required cooling performance, of the temperature control system. In particular, the electronic control and regulating unit can transmit a manipulated variable depending on the temperature of the at least one designated battery cell and/or the temperature of the designated heat transfer medium at the fluid inlet of the battery housing and/or the pressure of the designated heat transfer medium at the fluid inlet of the battery housing and/or the current strength of the at least one designated battery cell and/or the wet steam content of the designated heat transfer medium at the fluid drain of the battery housing, which variable is suitable for being able to provide the required temperature control performance, in particular the required heating performance and/or cooling performance, of the temperature control system.

The manipulated variable of the temperature control system can comprise a heating device manipulated variable and/or a pump manipulated variable and/or a heat transfer device manipulated variable.

In particular, the heating device manipulated variable and/or the pump manipulated variable and/or the heat transfer device manipulated variable can be dependent on one another or independent of one another.

It is understood that the electronic control and/or regulating unit can transmit the heating device manipulated variable and/or the pump manipulated variable and/or the heat transfer device manipulated variable in such a way that a temperature control capability is always provided, whereby an operation optimized for the at least one designated battery cell, in particular a particularly high power density and/or a particularly long service life of the at least one battery cell, can be achieved. Preferably, a particularly energy-efficient provision of the required temperature control capability can be achieved at the same time.

The manipulated variable can expediently comprise a heating device manipulated variable.

A “heating device manipulated variable” is understood to mean a manipulated variable by means of which the heating device can vary, in particular increase or decrease, a first temperature of the heat transfer medium in the collecting container.

The pump can pump a designated heat transfer medium with a first temperature, in particular with an increased temperature, from the collecting container into the battery housing. Due to its increased temperature, the designated heat transfer medium can transfer heat to at least one designated battery cell. This makes it possible for a designated battery cell to provide or absorb a high power density more rapidly, even at low ambient temperatures, without having to accept disadvantages for the service life. This can improve the cold-start capability.

The manipulated variable can expediently comprise a pump manipulated variable.

A “pump manipulated variable” is understood to be a manipulated variable by which the pump can vary, in particular increase or decrease, a heat transfer medium volume flow.

The pump can provide a designated heat transfer medium volume flow through which a constant heat dissipation and/or heat supply to the at least one designated battery cell can be achieved. This makes it possible to achieve a temporally and spatially homogeneous temperature distribution of the at least one designated battery cell. Furthermore, an optimal temperature control of the at least one designated battery cell can be achieved.

In particular, this makes it possible to achieve a temporally and spatially homogeneous temperature distribution of the at least one designated traction battery. In other words, this can minimize a temperature difference between the hottest designated battery cell and the coldest designated battery cell and/or a temperature difference between the hottest point and the coldest point of a designated battery cell of a designated traction battery. In this way an optimal operation with maximum power density and at the same time minimal loss of service life of the at least one designated traction battery can be achieved.

Preferably, by varying the first temperature of the designated heat transfer medium in the collecting container in combination with varying the heat transfer medium volume flow, a further improved temperature control, in particular heating and/or cooling, of the at least one designated battery cell can be achieved.

The manipulated variable can expediently comprise a heat transfer device manipulated variable.

A “heat transfer device manipulated variable” is understood to mean a manipulated variable by which the heat transfer device can vary a second temperature of the designated heat transfer medium at the fluid drain of the condenser.

By varying a second temperature of the designated heat transfer medium at the fluid drain of the condenser, the temperature of the designated heat transfer medium at the fluid inlet of the battery housing can be influenced. This allows a temperature to be set at the fluid inlet of the battery housing. In this way, a temperature control, in particular a cooling and/or heating, of the at least one designated battery cell can be achieved so that, in particular in the case of high power consumption and/or power output, an optimized operation of the at least one designated battery cell with regard to service life and power consumption and/or power output can be achieved.

In particular, by varying the second temperature of the designated heat transfer medium at the fluid drain of the condenser in combination with varying the heat transfer medium volume flow, a further improved temperature control, in particular a cooling and/or a heating, of the at least one designated battery cell can be achieved.

Particularly preferably, by varying, in particular by increasing or decreasing, a first temperature of the heat transfer medium in the collecting container by a heating device in combination with varying, in particular by increasing or decreasing, a second temperature of the designated heat transfer medium at the fluid drain of the condenser in combination with varying, in particular by increasing or decreasing, the heat transfer medium volume flow, a further improved temperature control, in particular cooling and/or heating, of the at least one designated battery cell can be achieved.

Optionally, the temperature control system can comprise a heat transfer device which has a secondary fluid circuit, wherein the heat transfer device is designed to be able to vary the second temperature of the heat transfer medium at the fluid drain of the condenser depending on a secondary fluid circuit manipulated variable and the manipulated variable comprises the secondary fluid circuit manipulated variable.

The secondary fluid circuit can be designed as an air-conditioning circuit, as a coolant circuit, or can be used using the ambient air of the condenser.

The secondary fluid circuit can in particular be designed such that the amount of heat released or absorbed by the heat transfer medium in the heat transfer device can be influenced via the secondary fluid circuit. Cooling and/or heating of the at least one battery cell can thus be achieved using the temperature of the secondary fluid circuit.

Preferably, the secondary fluid circuit can be designed in particular such that a second temperature of a designated heat transfer medium at the fluid drain of the condenser can be reached faster and/or slower via the secondary fluid circuit than a second temperature that can be reached without a secondary fluid circuit.

Optionally, the temperature control system can comprise a heat transfer device which comprises a fan for conveying an air flow, wherein the heat transfer device is designed to be able to vary the second temperature of the heat transfer medium at the fluid drain of the condenser depending on a fan manipulated variable, and the manipulated variable comprises the fan manipulated variable.

The fan for conveying an air flow can in particular be designed such that the amount of heat emitted by the heat transfer medium in the heat transfer device can be influenced via the fan.

Preferably, the fan for conveying an air flow can be designed in particular such that a second temperature of a designated heat transfer medium at the fluid drain of the condenser can be reached faster and/or more slowly via the fan than a second temperature that can be reached without a fan.

Optionally, the temperature control system can have a pump which is designed as a diaphragm pump, in particular as a diaphragm pump which is designed to change a conveying direction of the heat transfer medium.

A “diaphragm pump” is understood to be a device having a movable diaphragm and used for conveying liquids and/or gases, which is particularly insensitive to continuous stress and impurities in the conveyed material and is therefore particularly robust. In particular, the diaphragm pump can pump two-phase flows, i.e. a mixture of liquid and gaseous phases.

Another advantage of the diaphragm pump is that it can be designed to be directionally reversible. In other words, the diaphragm pump can be designed so that it can pump fluid in two flow directions, in particular two opposite flow directions.

A reversible diaphragm pump with the ability to pump two-phase flows can, depending on the selected pumping direction, pump a designated heat transfer medium from the lower region of the battery housing and/or from the upper region of the battery housing. In otherwords, a designated fluid volume flow, in particular a designated heat transfer medium volume flow, can be conveyed in both directions of the temperature control circuit.

In this way, a heating effect of the at least one designated battery cell can be achieved by causing vapor condensation within the battery housing. In this way, an advantageous temperature for the operation of the at least one designated battery cell with optimal power density and/or a homogeneous temperature distribution within the battery housing can be achieved more quickly.

Optionally, the temperature control system can have a sensor to determine the conductivity of the heat transfer medium.

If the proportion of a designated heat transfer medium in the temperature circuit falls below a certain value, this can affect the temperature control performance of the temperature control system.

Furthermore, the temperature control system preferably has a first sensor and a second sensor, each configured to determine the conductivity of a medium in the temperature control circuit, wherein the first sensor is in fluidic communication with the lower region of the battery housing and the second sensor is in fluidic communication with an upper region of the battery housing.

With a second sensor, the measurement accuracy of the conductivity of a medium can be increased. The conductivity can be used to determine a property of a fluid. In particular, it can be determined whether contamination with other fluid components is present. Such contamination can influence the conductivity of a fluid, in particular of a heat transfer medium.

Furthermore, the temperature control system can have a third sensor, in particular a sensor which is designed to determine a temperature of the designated heat transfer medium. In particular, the third sensor can be in fluidic communication with the lower region of the battery housing, preferably at the fluid inlet of the battery housing.

Furthermore, the temperature control system can have a fourth sensor, in particular a sensor which is designed to determine a pressure of the designated heat transfer medium in the temperature control system. In particular, the fourth sensor can be in fluidic communication with the lower region of the battery housing, preferably at the fluid inlet of the battery housing.

Tests have shown that an advantageous temperature distribution with simultaneous temperature control efficiency can be achieved with a wet steam content less than or equal to 75%, preferably less than or equal to 60%, preferably less than or equal to 53% and particularly preferably less than or equal to 50%. Furthermore, an advantageous temperature distribution with simultaneous temperature control efficiency can be achieved with a wet steam content less than or equal to 45%, preferably less than or equal to 40% and particularly preferably less than or equal to 35%. In particular, it has been shown that a wet steam content less than or equal to 50% can contribute to a particularly homogeneous temperature control of the battery cell. In other words, any inhomogeneity in the temperature control of the at least one battery cell can be reduced or prevented by the wet steam content proposed here.

Furthermore, tests have shown that an advantageous temperature distribution with simultaneous temperature control efficiency is achieved with a wet steam content greater than or equal to 1%, preferably greater than or equal to 10%, preferably greater than or equal to 20% and particularly preferably greater than or equal to 35%. Furthermore, an advantageous temperature distribution with simultaneous temperature control efficiency is achieved with a wet steam content greater than or equal to 45%, preferably greater than or equal to 50%, particularly preferably greater than or equal to 53%.

The wet steam content can be calculated using a heat balance, in particular a heat balance around the battery housing. From a current flowing through a designated battery cell contained in the battery housing and a temperature of this designated battery cell, a heat loss input of this designated battery cell can be calculated. As an alternative to a temperature of this designated battery cell, a pressure of the designated heat transfer medium can be used, in particular a pressure at the fluid inlet of the battery housing, preferably in combination with a temperature of the heat transfer medium, in particular a temperature of the heat transfer medium at the fluid inlet of the battery housing. From a heat balance together with a designated heat transfer medium volume flow, the wet steam content of a designated heat transfer medium can now be determined, in particular the wet steam content at the fluid drain of the battery housing. The designated heat transfer medium volume flow can be generated and adjusted with the pump, in particular by changing a pump manipulated variable. The wet steam content can be adjusted by the pump, in particular the wet steam content at the fluid drain of the battery housing, in particular by varying the heat transfer medium volume flow, in particular by changing a pump manipulated variable. This calculation of the wet steam content can be transferred to a traction battery having a large number of battery cells.

In particular, the wet steam content in the two-phase region can be determined from a pressure of the designated heat transfer medium, in particular the pressure of the designated heat transfer medium at the fluid inlet of the battery housing, and a current flowing through a designated battery cell accommodated in the battery housing. At a constant temperature of the designated heat transfer medium in the two-phase range, the specific heat capacity of the designated heat transfer medium depends on the pressure of the designated heat transfer medium. Together with the heat transfer medium volume flow, the amount of heat absorbed can be determined using this. Based on test data with the specific heat transfer medium, in particular test data taking into account the proportion of the heat transfer medium in the fluid or the foreign component in addition to the heat transfer medium, the specific heat capacity of the fluid and from this the wet steam content of the fluid can be determined from the pressure.

Since the thermal energy of the liquid portion of the heat transfer medium that can be absorbed by a temperature change is small compared to the thermal energy that can be absorbed by evaporation of the heat transfer medium, the wet steam content can be determined, in particular determined to a good approximation, in particular the wet steam content at the fluid drain of the battery housing, without determining a temperature of the liquid heat transfer medium, in particular a temperature of the liquid heat transfer medium at the fluid inlet of the battery housing. A temperature sensor, in particular a temperature sensor at the fluid inlet of the battery housing, can increase the accuracy of the determination of the wet steam content of the designated heat transfer medium.

Preferably, the temperature control system is characterized by the following features:
a three-way valve is arranged between the condenser of the heat transfer device and the battery housing;
the three-way valve is at least indirectly fluidically connected to the collecting container;
the three-way valve is designed to provide a fluidic connection between the battery housing and the condenser and/or a fluidic connection between the battery housing and the collecting container depending on a three-way valve manipulated variable, and
the manipulated variable comprises the three-way valve manipulated variable.

A “three-way valve” is a device that has three connections through which a flowing fluid can be conducted. In particular, the three-way valve can be designed to be controllable so that a fluid can be conducted depending on the control of the three-way valve.

The three-way valve can be connected directly or indirectly to the battery housing and/or to the condenser and/or the collecting container. In particular, the three-way valve can be arranged adjacent to the battery housing and/or the condenser and/or the collecting container or can be part of a line between the battery housing and the condenser and/or a line between the battery housing and the collecting container. The three-way valve can be part of the battery housing and/or part of the condenser and/or part of the collecting container. In particular, the three-way valve together with the battery housing and/or the condenser and/or the collecting container can be designed as an integral component.

The three-way valve can fluidically connect the fluid drain of the battery housing to the condenser in the designated flow direction of the designated heat transfer medium and/or fluidically connect the battery housing to the collecting container.

When the three-way valve fluidically connects the battery housing to the collecting container, the three-way valve can direct the designated heat transfer medium past the heat transfer device and the condenser so that the heat transfer medium does not flow through the heat transfer device and the condenser. In otherwords, the designated heat transfer medium can be pumped from the collecting container to the battery housing and from there back to the collecting container via the three-way valve. Since the designated heat transfer medium is not conducted through the condenser, it does not release any heat there. In addition, the heat transfer medium can be heated by the heat emitted to the heat transfer medium by the at least one designated battery cell. The heat transfer medium thus absorbs heat from the designated battery cell each time it flows past the at least one designated battery cell. This increases the temperature of the heat transfer medium. In other words, the at least one designated battery cell is no longer being actively cooled by the temperature control circuit. This allows the at least one designated battery cell to be brought more rapidly into a temperature state in which a high power density can be provided. This can improve the cold-start capability of the battery system.

The three-way valve can fluidically connect the battery housing to the condenser and the collecting container so that a portion of the designated heat transfer medium volume flow can be guided first through the condenser and then into the collecting container and a complementary portion of the heat transfer medium volume flow can be conducted past the condenser into the collecting container. In other words, it is possible to set an intermediate state between the fluidic connection between the battery housing and the condenser and the fluidic connection between the battery housing and the collecting container. This allows the temperature control performance of the temperature control system to be adjusted in even finer increments. This can be used particularly advantageously during the transition from the phase using the cold-start capability to the control operation of the temperature control system.

With a direction-reversible diaphragm pump, the conveying direction of a designated heat transfer medium can be adjusted such that a heating effect of the at least one designated battery cell can be achieved by vapor condensation setting in within the battery housing. In this way, an advantageous temperature for the operation of the at least one designated battery cell with optimal power density and/or a homogeneous temperature distribution within the battery housing can be achieved more quickly.

Alternatively, the temperature control system can comprise a first three-way valve and a second three-way valve. The second three-way valve can be located between the pump and the battery housing. The second three-way valve can be fluidically connected to the pump with its first connection, fluidically connected to the battery housing with its second connection, and fluidically connected to the collecting container with its third connection. The first three-way valve can be fluidically connected to the battery housing with its first connection, to the heat transfer device with its second connection, and to the pump with its third connection.

The electronic control and/or regulating unit can be operatively connected to the first three-way valve and/or the second valve. In particular, the electronic control and/or regulating unit can transmit the first three-way valve manipulated variable to the first three-way valve and/or transmit a second three-way valve manipulated variable to the second valve.

The first three-way valve and the second three-way valve can be designed to be controllable and/or regulatable in such a way that the heat transfer medium can be conveyed from the pump via the first three-way valve into the battery housing, in particular through the fluid drain of the battery housing into the battery housing. The heat transfer medium can be pumped from the battery housing back into the collecting container through the second three-way valve. In other words, the conveying direction of the heat transfer medium through the battery housing can be reversed. In this way, a heating function can be achieved for at least one battery cell designated to be accommodated in the battery housing.

Alternatively, the temperature control system can comprise a first three-way valve and a second three-way valve. The first three-way valve can be fluidically connected with its first connection to the battery housing, with its second connection to the heat exchanger and with its third connection to the third connection of the second three-way valve. The second three-way valve can be arranged between the heat exchanger and the collecting container. The second three-way valve can be fluidically connected to the heat exchanger with its first connection, fluidically connected to the collecting container with its second connection, and fluidically connected to the third connection of the first three-way valve with its third connection. With the arrangement of the first and second three-way valve proposed here, it can be achieved that the designated heat transfer medium can optionally flow around the condenser. The first three-way valve and the second three-way valve can be combined in a multi-way valve, in particular a five-way valve, so that they form a structural unit.

A structural unit of a plurality of three-way valves in the form of a multi-way valve, in particular a five-way valve, can also advantageously be transferred to a different arrangement and also a different number of three-way valves.

The temperature control system can include a third three-way valve and a fourth three-way valve. The temperature control system can have a first connecting element and/or a second connecting element. The third three-way valve and/or the fourth three-way valve can be arranged between the pump and the collecting container. The third three-way valve can be fluidically connected with its first connection to the second connection of the fourth three-way valve, with its second connection to the collecting container and with its third connection to the third connection of a second connecting element. The fourth three-way valve can be fluidically connected with its first connection to the third connection of a first connecting element, with its second connection to the first connection of the third three-way valve, and with its third connection to the pump.

The first connecting element and/or the second connecting element can be designed as a three-way valve or as a T-piece or as another connecting element with three connections. The first connecting element and/or the second connecting element can be arranged between the battery housing and the pump. The first connecting element can be fluidically connected with its first connection to the battery housing, with its second connection to the first connection of the second connecting element, and with its third connection to the first connection of the fourth three-way valve. The second connecting element can be fluidically connected with its first connection to the second connection of the first connecting element, with its second connection to the pump, and with its third connection to the third connection of the third three-way valve.

The third three-way valve and the fourth three-way valve can, in particular in operative connection with the first connecting element and the second connecting element, advantageously reverse the designated flow direction of the designated heat transfer medium in the temperature control system, wherein the conveying direction of the pump can remain the same.

The first three-way valve and/or the second three-way valve and/or the third three-way valve and/or the fourth three-way valve and/or the first connecting element and/or the second connecting element can be designed to be controllable and/or regulatable such that the designated heat transfer medium, in particular the liquid designated heat transfer medium, can be conveyed by the pump from the battery housing into the collecting container. As a result, gaseous designated heat transfer medium from the collecting container, in particular gaseous heat transfer medium generated by a heating device in the collecting container, can be sucked into the battery housing. In other words, the flow direction of the designated heat transfer medium through the battery housing can be reversed, in particular with a conventional pump. The gaseous designated heat transfer medium thus conveyed into the battery housing can condense on at least one designated battery cell accommodated in the battery housing. This allows this designated battery cell to be heated particularly rapidly. In particular, a heating function with a pronounced phase heating can be achieved.

The third three-way valve and the fourth three-way valve can be combined in a multi-way valve, in particular a five-way valve, so that they form a structural unit. In this case, the multi-way valve has a fluidic connection to the collecting container and a fluidic connection to the pump, in particular to a suction side of the pump. The first and/or the second connecting element can also be integrated into the above multi-way valve, whereby the multi-way valve has a fluidic connection to the battery housing and/or a second fluidic connection to the pump, in particular to a pressure side of the pump.

It is understood that the electronic control and/or regulating unit can transmit the heating device manipulated variable and/or the pump manipulated variable and/or the heat transfer device manipulated variable, in particular the secondary fluid circuit manipulated variable and/or the fan manipulated variable, and/or the three-way valve manipulated variable, in such a way that a temperature control capability is always provided, whereby an operation optimized for the at least one designated battery cell, in particular a particularly high power density and/or a particularly long service life, in particular with particularly energy-efficient temperature control, can be achieved.

The temperature control system can expediently be designed to limit an electrical power of the at least one battery cell.

Preferably, the available electrical power of the at least one designated battery cell can be limited, in particular set to zero, if the temperature of the at least one designated battery cell is so high that the at least one designated battery cell could thermally escalate if the temperature continues to rise.

The electronic control and regulating unit can be designed to receive a temperature of the at least one designated battery cell and to transmit a signal suitable for limiting an electrical power of the at least one designated battery cell to a device suitable for limiting the electrical power of the at least one designated battery cell, in particular to the battery management system.

Optionally, the temperature control system can have a safety valve to protect against a negative pressure in the temperature control circuit.

A “safety valve” is understood to mean any valve that can equalize the pressure in pressurized systems when a specified overpressure is exceeded and/or a specified negative pressure is undershot. In particular, a safety valve can be designed to protect a pressurized system from damage by equalizing the pressure.

Temperature fluctuations can lead to pressure changes in a temperature control system. This can influence the temperature control efficiency of the temperature control system. In particular, the cooling efficiency can be negatively influenced by low temperature and thus lower pressure in the temperature control system.

The safety valve can open in the event of negative pressure in the temperature control system relative to the environment, whereby a medium can enter the temperature control device from the environment of the safety valve and the minimum pressure in the temperature control system can be limited, thereby preventing mechanical failure of a component of the temperature control system.

The safety valve can be designed so that, in the event of a negative pressure in the temperature control system in relation to the environment of the temperature control system, the maximum negative pressure in the temperature control system is less than or equal to 0.03 N/mm², preferably less than or equal to 0.02 N/mm², preferably less than or equal to 0.015 N/mm² and particularly preferably less than or equal to 0.0125 N/mm². Furthermore, the safety valve can be designed so that the maximum negative pressure in the temperature control system is less than or equal to 0.01 N/mm², preferably less than or equal to 0.0075 N/mm², preferably less than or equal to 0.005 N/mm², and particularly preferably less than or equal to 0.0025 N/mm².

The temperature control system expediently has a safety valve against overpressure in the temperature control circuit.

The safety valve can open in the event of excess pressure in the temperature control system relative to the environment, whereby a medium can escape from the temperature control system to the environment and the maximum pressure in the temperature control system can be limited.

The safety valve can be designed so that, in the event of an excess pressure in the temperature control system in relation to the environment of the temperature control system, the maximum excess pressure in the temperature control system is less than or equal to 0.31 N/mm², preferably less than or equal to 0.285 N/mm², preferably less than or equal to 0.265 N/mm² and particularly preferably less than or equal to 0.25 N/mm². Furthermore, the safety valve can be designed so that the maximum excess pressure in the temperature control system is less than or equal to 0.235 N/mm², preferably less than or equal to 0.22 N/mm², preferably less than or equal to 0.2 N/mm², and particularly preferably less than or equal to 0.175 N/mm².

The temperature control system can have a filling device.

A “filling device” is understood to mean any device for filling a temperature control system with a fluid. In particular, a filling device is understood to be a device by means of which a temperature control system can be filled with a designated heat transfer medium.

The filling device can preferably be arranged above the battery housing. Furthermore, the filling device can preferably be arranged below a safety valve. Preferably, the filling device can be arranged between the heat transfer device and the collecting container. Particularly preferably, the filling device can be arranged adjacent to the collecting container, again preferably in the upper region of the collecting container. Finally, the filling device can be arranged integrally with the collecting container, preferably in the upper region of the collecting container.

The temperature control system can include a drainage device.

A “drainage device” is understood to mean any device for draining a fluid from a temperature control system. In particular, a drainage device is understood to mean a device for draining a designated heat transfer medium from a temperature control system.

The drainage device can preferably be arranged at the point with the lowest geodetic height of the temperature control system. Preferably, the drainage device can be arranged in the lower region of the battery housing. Further preferably, the drainage device can be integrally connected to the lower region of the battery housing.

One or more components of the temperature control system can be arranged inside the motor vehicle, in particular the battery housing of the traction battery and/or the collecting container and/or the heat transfer device and/or the pump.

According to a second aspect of the invention, the object is achieved by a method for controlling the temperature control behavior of a temperature control system, in particular a temperature control system according to the first aspect of the invention, comprising the following steps:
determining a temperature of at least one battery cell; and/or
determining a current strength of at least one battery cell; and/or
determining a wet steam content at the fluid drain of a battery housing; and
determining a state of the at least one battery cell, in particular determining whether there is a heating requirement, a cooling requirement or a fault.

In this regard, the following is explained conceptually:

“Heating requirement” is understood to mean a state in which a temperature of at least one battery cell is below a temperature required for optimal operation of the at least one battery cell, in particular for a maximum power density for power consumption and/or power output with minimal influence on the service life of the at least one battery cell.

“Cooling requirement” is understood to mean a state in which a temperature of at least one battery cell is above a temperature required for optimal operation of the at least one battery cell, in particular for a maximum power density for power consumption and/or power output with minimal influence on the service life of the at least one battery cell.

The term “fault” is understood to mean a state in which a temperature of at least one battery cell is above a maximum temperature for safe operation, in particular a temperature for operation without thermal overload of the at least one battery cell.

Here, a method for controlling the temperature control behavior of the temperature control system is proposed, in particular the temperature control system according to the first aspect of the invention, which can determine a state, in particular a heating requirement and/or a cooling requirement and/or a fault, of at least one battery cell on the basis of a temperature of at least one battery cell and/or a wet steam content at the fluid drain of the battery housing.

In the cooling requirement state, a required cooling performance can be determined from a temperature of at least one battery cell and an energy input, in particular an electrical power consumption and/or an electrical power output, of a battery cell. An energy input can be determined from the product of the square of the current applied to a battery cell and the internal resistance of this battery cell. An internal resistance of at least one battery cell can be stored in a device for storing and retrieving data depending on a temperature of a battery cell and/or an SOC (state of charge) of a battery cell. In this way, an internal resistance of a battery cell and thus an energy input can be determined depending on an SOC and/or a temperature of a battery cell. Using the energy input for a battery cell determined in this way and the temperature of the battery cell, the currently required cooling performance can be determined. On the basis of the cooling performance determined in this way, a heat transfer medium volume flow can be set via a pump. By determining a wet steam content in the fluid drain of a battery housing, a determined cooling performance can also be checked for physical plausibility and, in the event of a deviation, a maintenance requirement can be reported. A cooling performance determined in this way can be provided via a heat transfer device, in particular a condenser and further in particular via a secondary fluid circuit operatively connected to the condenser.

By means of the method, after determination of a fault, the second temperature of the heat transfer medium at the fluid drain of the condenser can be controlled and/or regulated, in particular minimized, in particular by specifying a corresponding heat transfer device manipulated variable, in particular by specifying a corresponding secondary fluid circuit manipulated variable or by specifying a corresponding fan manipulated variable and/or by specifying a corresponding pump manipulated variable.

In the event of a fault, the cooling performance of a temperature control system can be controlled and/or regulated by controlling and/or regulating a second temperature at the fluid drain of the condenser. In particular, the cooling performance of a temperature control system can be maximized by minimizing the second temperature at the fluid drain of the condenser. Particularly preferably, the temperature at the fluid inlet of a battery housing can be minimized by minimizing the second temperature at the fluid drain of the condenser.

The method can be used to limit the electrical power of the at least one battery cell after a fault has been determined, in particular to limit it completely.

By limiting, in particular by completely limiting, the electrical power of at least one battery cell in the event of a fault, it is possible to prevent the at least one battery cell from escalating thermally if the temperature continues to rise.

After determining a heating requirement, the method may comprise the following steps:
the heating device is controlled and/or regulated, in particular activated, by specifying a corresponding heating device manipulated variable; and/or
by specifying a corresponding three-way valve manipulated variable, a fluidic connection is provided between the battery housing and a collecting container, wherein the designated heat transfer medium is conducted past the condenser; and/or
by specifying a corresponding pump manipulated variable, the wet steam content at the fluid drain of the battery housing is controlled and/or regulated, in particular is minimized.

By activation of the heating device, a designated heat transfer medium in the collecting container can be heated. Alternatively, by means of an appropriately controlled three-way valve a designated heat transfer medium can be conducted from the collecting container through the battery housing, in particular past the condenser, and back into the collecting container. This allows the designated heat transfer medium to heat up with each cycle. Alternatively, by specifying a corresponding pump manipulated variable, the wet steam content in the fluid drain of the battery housing can be regulated and/or controlled, in particular minimized, in particular by condensation of the designated heat transfer medium in the battery housing. In this way, a heating effect can be achieved.

The method can comprise the following steps after determination of a cooling requirement:
by specifying a corresponding pump manipulated variable, the wet steam content at the fluid drain of the battery housing is controlled and/or regulated, in particular optimized; and/or
by specifying a corresponding heat transfer device manipulated variable, in particular by specifying a corresponding secondary fluid circuit manipulated variable or by specifying a corresponding fan manipulated variable, the second temperature of the heat transfer medium at the fluid drain of the condenser is controlled and/or regulated.

A wet steam component at the fluid drain of the battery housing can be controlled and/or regulated in an optimized manner by specifying a pump manipulated variable in such a way that the temperature control system can operate in a particularly energy-efficient manner.

By specifying a secondary fluid circuit manipulated variable or a fan manipulated variable, the amount of heat dissipated by a heat transfer medium volume flow in the condenser can be adjusted, in particular maximized or minimized. As a result, a second temperature of the heat transfer medium at the fluid drain of the condenser can also be controlled and/or regulated, in particular minimized.

The method can comprise a regulating system for controlling the temperature control behavior of the temperature control system, which can be model-based at least in some areas.

Model-based regulation can achieve a time-variable regulation, in particular real-time regulation and/or model-predictive look-ahead regulation.

It should be expressly noted that the subject-matter of the second aspect can advantageously be combined with the subject matter of the preceding aspect of the invention, both individually or cumulatively in any combination.

According to a third aspect of the invention, the object is achieved by a motor vehicle comprising a temperature control system according to the first aspect of the invention and/or set up to carry out a method according to the second aspect of the invention.

It should be understood that the advantages of a temperature control system according to the first aspect of the invention and/or of a method according to the second aspect of the invention, as described above, extend immediately to a motor vehicle having a temperature control system according to the first aspect of the invention and/or set up to carry out a method according to the second aspect of the invention.

It should be expressly noted that the subject-matter of the third aspect can advantageously be combined with the subject-matter of the preceding aspects of the invention, both individually and cumulatively in any combination.

Further advantages, details, and features of the invention can be found below in the described embodiments. In the figures, in detail:

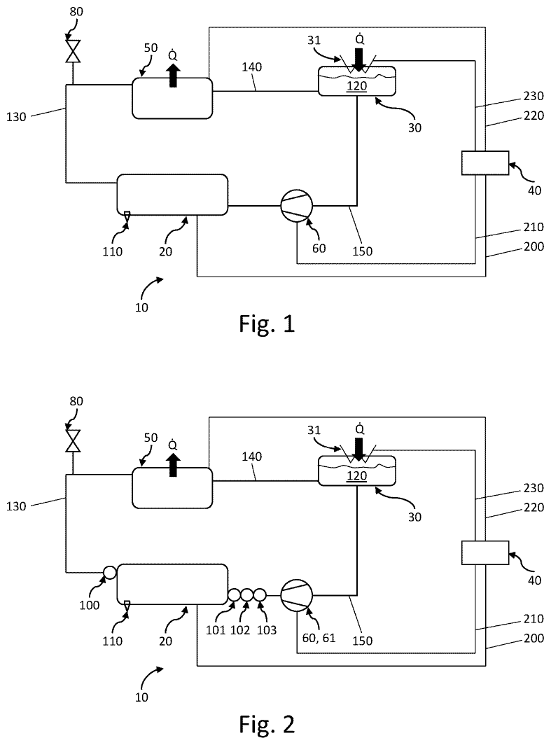

FIG. 1: is a schematic representation of a first embodiment of a temperature control system;

FIG. 2: is a schematic representation of a second embodiment of a temperature control system;

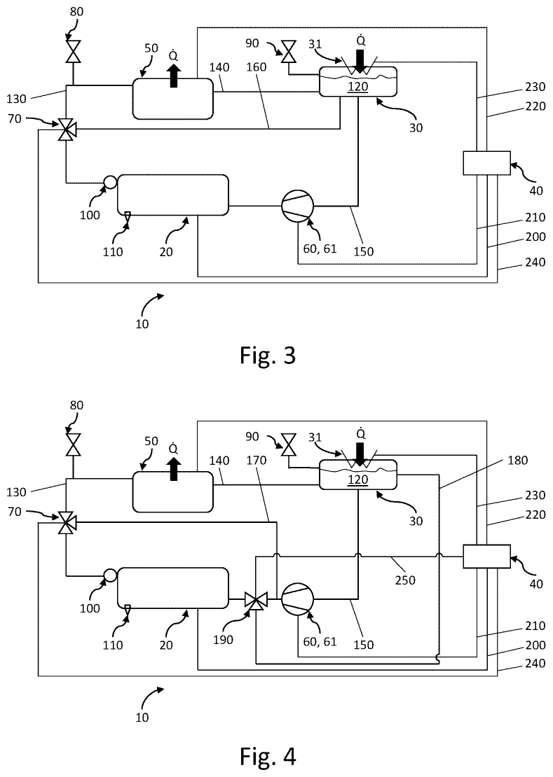

FIG. 3: is a schematic representation of a third embodiment of a temperature control system;

FIG. 4: is a schematic representation of a fourth embodiment of a temperature control system;

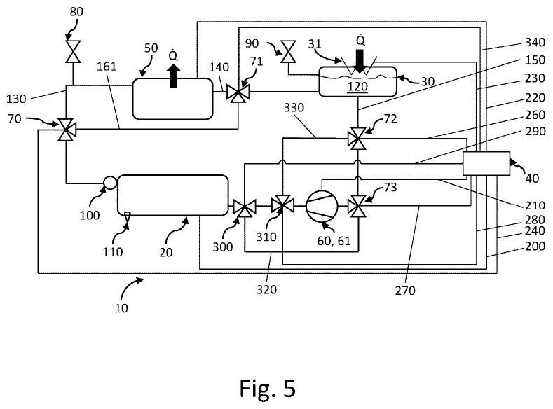

FIG. 5 is a schematic representation of a fifth embodiment of a temperature control system.

In the following description, the same reference signs denote the same components or features; in the interest of avoiding repetition, a description of a component made with reference to one drawing also applies to the other drawings. Furthermore, individual features that have been described in connection with one embodiment can also be used separately in other embodiments.

A first embodiment of a temperature control system 10 according to FIG. 1 consists essentially of a battery housing 20, a heat transfer device 50, a collecting container 30, and a pump 60.

The temperature control system 10 can be configured to control the temperature of a traction battery (not shown) of a motor vehicle (not shown) using a heat transfer medium 120 in a temperature control circuit (not indicated).

The battery housing 20 can have an enclosed interior with at least one receiving position for a battery cell, wherein a lower region of the battery housing 20 can be designed to receive the heat transfer medium 120 and the battery housing 20 can have an evaporation device for evaporating the heat transfer medium.

The heat transfer device 50 can have a condenser and can be designed to transfer heat from the heat transfer medium 120 to a fluid that is in operative connection with the heat transfer device 50.

The collecting container 30 can be designed to hold the heat transfer medium 120. The collecting container 30 can have a heating device 31.

With the temperature control system 10 designed in this way, a two-phase immersion cooling can be carried out.

The heat transfer device 50 can be fluidically connected to the battery housing 20 at least indirectly through a first line 130 and to the collecting container 30 at least indirectly through the second line 140. The collecting container 30 can be fluidically connected to the battery housing 20 at least indirectly via a third line 150. The pump 60 can be arranged between the battery housing 20 and the collecting container 30, in particular in the third line 150. As a result, the pump 60 can pump the heat transfer medium 120 from the collecting container 30 into the battery housing 20 and into the heat transfer device 50 and back into the collecting container 30. This makes it possible to cool at least one battery cell that is housed in a designated manner within the battery housing 20.

The temperature control system 10 can also have an electronic control and/or regulating unit 40, which is configured to receive a temperature of the at least one battery cell and/or a wet steam content at the fluid drain of the battery housing 20. The electronic control and regulating unit 40 can be configured to transmit a manipulated variable for controlling and/or regulating the temperature of the at least one battery cell and/or the wet steam content at the fluid drain of the battery housing 20.

The electronic control and/or regulating unit 40 can be operatively connected to the battery housing 20 at least indirectly via a first data line 200 and/or to the pump 60 at least indirectly via a second data line 210. In addition, the electronic control and/or regulating unit 40 can be operatively connected to the heat transfer device 50 at least indirectly via a third data line 220 and/or to the heating device 31 at least indirectly via a fourth data line 230.

Components that are functionally operatively connected to one another can also be arranged directly adjacent to one another, so that individual, multiple or all data lines can be dispensed with. Components that are functionally operatively connected to one another can also be in operative connection to one another without being arranged adjacent to one another.

In particular, the electronic control and/or regulating unit 40 can be operatively connected to the battery housing 20 in such a way that the electronic control and/or regulating unit can receive a temperature of the at least one battery cell and/or a wet steam content at the fluid drain of the battery housing 20. Preferably, the electronic control and/or regulating unit 40 can be operatively connected to the heating device 31 and/or the pump 60 and/or the heat transfer device 50 in such a way that the electronic control and/or regulating unit 40 can transmit a manipulated variable to the heating device 31 and/or the pump 60 and/or the heat transfer device 50.

The temperature control system 10 can also have a drainage device 110. The drainage device 110 can be arranged at the lowest point of the temperature control system 10. The drainage device 110 can be arranged in the lower region of the battery housing 20. The temperature control system 10 can also have a filling device 80. The filling device can be arranged above the battery housing 20.

A second embodiment of a temperature control system 10 according to FIG. 2 can have a sensor 100, in particular a sensor 100 arranged at the fluid drain of the battery housing 20, which can be designed to be able to determine the conductivity of a designated heat transfer medium 120.

The temperature control system 10 can have a second sensor 101, in particular a second sensor 101 arranged at the fluid inlet of the battery housing 20, which can be designed to be able to determine the conductivity of the designated heat transfer medium 120.

Furthermore, the temperature control system 10 can have a third sensor 102 and/or a fourth sensor 103; in particular, the third sensor 102 and the fourth sensor 103 can be arranged at the fluid inlet of the battery housing 20. The third sensor 102 can be designed to determine a temperature of the designated heat transfer medium 120. The fourth sensor 103 can be designed to determine a pressure of the designated heat transfer medium 120.

The temperature control system 10 can have a pump 60, which can be designed as a diaphragm pump 61. The pump 60, 61 can be designed to provide a variable heat transfer medium volume flow depending on a pump manipulated variable. Furthermore, the diaphragm pump 61 can be designed to change the pumping direction.

The representation of the pump 60 is not decisive for the conveying direction of the heat transfer medium 120. In other words, the pump can be configured to pump in two opposite pumping directions.

The electronic control and/or regulating unit 40 can be configured to control and/or regulate the wet steam content of the heat transfer medium 120, in particular at exit from the battery housing 20, by specifying the pump manipulated variable.

A third embodiment of a temperature control system 10 according to FIG. 3 can have a three-way valve 70 that can be arranged between the battery housing 20 and the heat transfer device 50, in particular in the first line 130. The three-way valve 70 can be at least indirectly fluidically connected to the battery housing 20 through its first connection and to the heat transfer device 50 through its second connection. With its third connection, the three-way valve 70 can be fluidically connected to the collecting container 30 at least indirectly through the fourth line 160.

The three-way valve 70 can also be designed to be controllable. In particular, the three-way valve 70 can be designed to be controllable in such a way that the heat transfer medium 120 can be pumped by the pump 60, 61 from the collecting container 30 into the battery housing 20 and from there back into the collecting container 30. In other words, the three-way valve 70 can be designed to be controllable in such a way that the heat transfer medium 120 is conducted past the heat transfer device 50, in particular is not conveyed through the heat transfer device 50. In this way, a heating function of the temperature control system 10 can be achieved.

The electronic control and/or regulating unit 40 can be operatively connected to the three-way valve 70, in particular at least indirectly via a fifth data line 240.

The electronic control and/or regulating unit 40 can be configured to control the three-way valve 70 by specifying a three-way valve manipulated variable when the at least one battery cell requires heating, so that the heat transfer medium 120 is conducted past the heat transfer device 50.

The temperature control system 10 can have a safety valve 90 against low pressure and/or against excess pressure. The safety valve 90 can be arranged at the highest point of the temperature control system 10. In particular, the safety valve 90 can be arranged in the upper region of the collecting container 30.

The filling device can be arranged below a safety valve 90.

A fourth embodiment of a temperature control system 10 according to FIG. 4 can have a valve 190, which can be arranged between the pump 60, 61 and the battery housing 20. In particular, the valve 190 can be designed as a three-way valve. The valve 190 designed as a three-way valve can be fluidically connected with its first connection to the pump 60, 61, with its second connection to the battery housing 20 and with its third connection, in particular at least indirectly by a sixth line 180, to the collecting container 30. In this embodiment, the three-way valve 70 can be fluidically connected to the pump 60, 61 with its third connection, in particular at least indirectly by a fifth line 170.

The electronic control and/or regulating unit 40 can be operatively connected to the valve 190, in particular at least indirectly by a sixth data line 250.

The three-way valve 70 and the valve 190 can also be designed to be controllable. In particular, the three-way valve 70 and the valve 190 can be designed to be controllable in such a way that the heat transfer medium 120 can be conveyed by the pump 60, 61 via the three-way valve 70 into the battery housing, in particular through the fluid drain of the battery housing 20 into the battery housing. From the battery housing 20, the heat transfer medium 120 can be conveyed through the valve 190 back into the collecting container 30. In other words, the conveying direction of the heat transfer medium 120 through the battery housing 20 can be reversed. In this way, a heating function of the at least one battery cell can be achieved.

A fifth embodiment of a temperature control system 10 according to FIG. 5 can have a three-way valve 70 and a second three-way valve 71. The three-way valve 70 can be arranged between the battery housing 20 and the heat transfer device 50, in particular in the first line 130. The second three-way valve 71 can be arranged between the heat transfer device 50 and the collecting container 30, in particular in the second line 140. The three-way valve 70 can be fluidically connected with its first connection to the battery housing 20, with its second connection to the heat transfer device 50, and with its third connection to the third connection of the second three-way valve 71. The second three-way valve 71 can be arranged between the heat transfer device 50 and the collecting container 30. The second three-way valve 71 can be fluidically connected with its first connection to the heat transfer device 50, with its second connection to the collecting container 30 and with its third connection to the third connection of the three-way valve 70, in particular via the fourth line 161. The second three-way valve 71 is connected to the electronic control and/or regulating unit 40 via the eleventh data line 340.

The temperature control system 10 can have a third three-way valve 72 and a fourth three-way valve 73. The temperature control system 10 can have a first connecting element 300 and/or a second connecting element 310. The third three-way valve 72 and/or the fourth three-way valve 73 can be arranged between the pump 60, 61 and the collecting container 30, in particular in the third line 150. The third three-way valve 72 can be fluidically connected with its first connection to the second connection of the fourth three-way valve 73, with its second connection to the collecting container 30, and with its third connection to the third connection of a second connecting element 310. The fourth three-way valve 73 can be fluidically connected with its first connection to the third connection of a first connecting element 300, with its second connection to the first connection of the third three-way valve 72, and with its third connection to the pump 60, 61.

The first connecting element 300 and/or the second connecting element 310 can be designed as a three-way valve or as a T-piece or as another connecting element with three connections. The first connecting element 300 and/or the second connecting element 310 can be arranged between the battery housing 20 and the pump 60, 61, in particular in the third line 150. The first connecting element 300 can be fluidically connected with its first connection to the battery housing 20, with its second connection to the first connection of the second connecting element 310, and with its third connection to the first connection of the fourth three-way valve 73. In particular, the first connecting element 300 can be fluidically connected with its third connection to the first connection of the fourth three-way valve 73 via the ninth line 320. The second connecting element 310 can be fluidically connected with its first connection to the second connection of the first connecting element 300, with its second connection to the pump 60, 61, and with its third connection to the third connection of the third three-way valve 72. In particular, the second connecting element 310 can be fluidically connected with its third connection to the third connection of the third three-way valve 72 via the tenth line 330.

The three-way valve 70 and/or the second three-way valve 71 and/or the third three-way valve 72 and/or the fourth three-way valve 73 and/or the first connecting element 300 and/or the second connecting element 310 can be designed to be controllable and/or regulatable such that the designated heat transfer medium 120, in particular the liquid designated heat transfer medium 120, can be conveyed by the pump 60, 61 from the battery housing 20 into the collecting container 30. As a result, gaseous designated heat transfer medium 120 can be sucked from the collecting container 30 into the battery housing 20. In other words, the flow direction of the designated heat transfer medium 120 through the battery housing 20 can be reversed, in particular with a conventional pump 60. The gaseous designated heat transfer medium 120 thus conveyed into the battery housing 20 can condense on at least one designated battery cell accommodated in the battery housing 20. This allows this designated battery cell to be heated particularly rapidly. In particular, a heating function with a pronounced phase heating can be achieved.

The electronic control and/or regulating unit 40 can be operatively connected to the three-way valve 72, in particular at least indirectly via a seventh data line 260.

The electronic control and/or regulating unit 40 can be operatively connected to the three-way valve 73, in particular at least indirectly via an eighth data line 270.

The electronic control and/or regulating unit 40 can be operatively connected to the first connecting element 300, in particular at least indirectly via a tenth data line 290, in particular if it is designed as a three-way valve.

The electronic control and/or regulating unit 40 can be operatively connected to the first connecting element 310, in particular at least indirectly via a ninth data line 280, in particular if it is designed as a three-way valve.

### LIST OF REFERENCE SIGNS

10 temperature control system
20 battery housing
30 collecting container
31 heating device
40 electronic control and/or regulating unit
50 heat transfer device
60 pump
61 diaphragm pump
70 three-way valve
71 second three-way valve
72 third three-way valve
73 fourth three-way valve
80 filling device
90 safety valve (against low pressure/excess pressure)
100 sensor
101 second sensor
102 third sensor
103 fourth sensor
110 drainage device
120 heat transfer medium
130 first line
140 second line
150 third line
160 fourth line
161 fourth line
170 fifth line
180 sixth line
190 valve
200 first data line
210 second data line
220 third data line
230 fourth data line
240 fifth data line
250 sixth data line
260 seventh data line
270 eighth data line
280 ninth data line
290 tenth data line
300 first connecting element
310 second connecting element
320 ninth line
330 tenth line
340 eleventh data line

1. A temperature control system for controlling a temperature of a traction battery of a motor vehicle using a heat transfer medium in a temperature control circuit, the temperature control system comprising:
a battery housing which has an evaporation device for evaporating the heat transfer medium and which forms a closed interior with at least one receiving position for at least one battery cell, a lower region of the battery housing being designed to receive the heat transfer medium;
a collecting container for receiving the heat transfer medium, in particular a collecting container operatively connected to a heating device for heating the heat transfer medium, in particular with a heating device which is designed to be able to vary a first temperature of the heat transfer medium in the collecting container depending on a heating device manipulated variable;
a heat transfer device which has a condenser for cooling the heat transfer medium designed to vary a second temperature of the heat transfer medium at a fluid drain of the condenser depending on a heat transfer device manipulated variable;
a pump for conveying the heat transfer medium, the pump being designed to vary a heat transfer medium volume flow depending on a pump manipulated variable; and
an electronic control and/or regulating unit, wherein the electronic control and/or regulating unit is designed to receive a temperature a designated heat transfer medium and/or a temperature of the at least one designated battery cell, and/or a current strength of the at least one designated battery cell, and/or wet steam content at the fluid drain of the battery housing and, in accordance with at least one manipulated variable of the temperature control system, to control and/or regulate the temperature of the at least one designated battery cell and/or the wet steam content at the fluid drain of the battery housing.

2. The temperature control system according to claim 1, wherein the manipulated variable comprises the heating device manipulated variable.

3. The temperature control system according to claim 1, wherein the manipulated variable comprises the pump manipulated variable.

4. The temperature control system according to claim 1, wherein the manipulated variable comprises the heat transfer device manipulated variable.

5. The temperature control system according to claim 4, wherein:
the heat transfer device has a secondary fluid circuit,
the heat transfer device is designed to vary the second temperature of the heat transfer medium at the fluid drain of the condenser depending on a secondary fluid circuit manipulated variable; and
the manipulated variable comprises the secondary fluid circuit manipulated variable.

6. The temperature control system according to claim 4, wherein:
the heat transfer device has a fan for conveying an air flow, wherein the heat transfer device is designed to vary the second temperature of the heat transfer medium at the fluid drain of the condenser depending on a fan manipulated variable; and
the manipulated variable comprises the fan manipulated variable.

7. The temperature control system according to claim 1, wherein the pump is a diaphragm pump designed to change a conveying direction of the heat transfer medium.

8. The temperature control system according to claim 1, further comprising a sensor for determining conductivity of the heat transfer medium.

9. The temperature control system according to claim 1, wherein:
a three-way valve is arranged between the condenser of the heat transfer device and the battery housing;
the three-way valve is at least indirectly fluidically connected to the collecting container;
the three-way valve is designed to provide a fluidic connection between the battery housing and the condenser and/or a fluidic connection between the battery housing and the collecting container depending on a three-way valve manipulated variable; and
the manipulated variable comprises the three-way valve manipulated variable.

10. The temperature control system according to claim 1, wherein the temperature control system is designed to limit an electrical power of the at least one battery cell.

11. A method for controlling a temperature control behavior of a temperature control system, comprising steps of:
determining a temperature of at least one battery cell; or
determining a current strength of at the least one battery cell; or
determining a wet steam content at a fluid drain of a battery housing; and
determining a state of the at least one battery cell as one of a heating requirement, a cooling requirement, or a fault.

12. The method according to claim 11, claim 1, wherein after determination of a fault, a second temperature of a heat transfer medium at the fluid drain of a condenser is controlled and/or regulated to be minimized by specifying at least one of: a corresponding secondary fluid circuit manipulated variable, a corresponding fan manipulated variable, or a corresponding pump manipulated variable.

13. The method according to claim 11, wherein after determination of a fault, electrical power of the at least one battery cell is limited.

14. The method according to claim 11, wherein after determination of a heating requirement, at least one of:
a heating device is controlled and/or regulated by specifying a corresponding heating device manipulated variable;
by specifying a corresponding three-way valve manipulated variable, a fluidic connection is provided between the battery housing and a collecting container, wherein the heat transfer medium is conducted past the condenser; or
by specifying a corresponding pump manipulated variable, the wet steam content at the fluid drain of the battery housing is controlled and/or regulated to be minimized.

15. The method according to claim 11, wherein after determination of a cooling requirement:
by specifying a corresponding pump manipulated variable, the wet steam content at the fluid drain of the battery housing is controlled and/or regulated to be optimized; and/or
by specifying a corresponding secondary fluid circuit manipulated variable or by specifying a corresponding fan manipulated variable, a second temperature of a heat transfer medium at the fluid drain of a condenser is controlled and/or regulated.

16. The method according to claim 11, a regulation for controlling the temperature control behavior of the temperature control system is model-based at least in some regions.

17. A motor vehicle comprising a temperature control system, comprising:
a battery housing which has an evaporation device for evaporating the heat transfer medium and which forms a closed interior with at least one receiving position for at least one battery cell, a lower region of the battery housing being designed to receive the heat transfer medium;
a collecting container for receiving the heat transfer medium, in a particular a collecting container operatively connected to a heating device for heating the heat transfer medium, in particular with a heating device which is designed to be able to vary a first temperature of the heat transfer medium in the collecting container depending on a heating device manipulated variable;
a heat transfer device which has a condenser for cooling the heat transfer medium designed to vary a second temperature of the heat transfer medium at a fluid drain of the condenser depending on a heat transfer device manipulated variable;
a pump for conveying the heat transfer medium, the pump being designed to vary a heat transfer medium volume flow depending on a pump manipulated variable; and
an electronic control and/or regulating unit, wherein the electronic control and/or regulating unit is designed to receive a temperature a designated heat transfer medium and/or a temperature of the at least one designated battery cell, and/or a current strength of the at least one designated battery cell, and/or wet steam content at the fluid drain of the battery housing and, in accordance with at least one manipulated variable of the temperature control system, to control and/or regulate the temperature of the at least one designated battery cell and/or the wet steam content at the fluid drain of the battery housing.
